(19) United States
(12) Patent Application Publication
(10) Pub. No.: US 2022/0024078 A1
(43) Pub. Date: Jan. 27, 2022

(54) Articles With Self-Supporting Overhangs And Manufacture Thereof

(71) Applicant: The Procter & Gamble Company, Cincinnati, OH (US)

(72) Inventors: Christian Gerhard Friedrich Gerlach, St. Gilles (BE); Pedro Vincent Vandecappelle, Wetteren (BE)

(21) Appl. No.: 16/939,151

(22) Filed: Jul. 27, 2020

(51) Int. Cl. B29B 11/06; B33Y 80/00; B29C 49/02

(52) U.S. Cl. CPC B29B 11/06; B33Y 10/00; B29C 49/02; B33Y 80/00

(57) ABSTRACT

A preform created through additive manufacturing and a process for blow molding an additive manufactured preform. The preform has one or more self-supporting overhangs.

### FIELD OF THE INVENTION

The present invention relates to articles with overhangs that are self-supporting and methods for making said articles by additive manufacturing.

### BACKGROUND OF THE INVENTION

Additive Manufacturing (AM) describes technologies that build 3D articles by adding layer-upon-layer of one or more materials. The term AM encompasses many technologies including subsets like 3D printing, Rapid Prototyping (RP), Direct Digital Manufacturing (DDM), layered manufacturing and additive fabrication. Common to AM technologies is the use of a computer, 3D modeling software (Computer Aided Design or CAD), machine equipment, and layering material. For example, a CAD sketch may be used to provide data to equipment that lays downs or adds successive layers of liquid, powder, sheet material, polymer, or other material, in a layer-upon-layer fashion to fabricate a 3D article. Advantages of 3D printing articles include less material usage, lower labor costs, lower machine operation costs, and the ability for rapid prototyping of designs.

However, there are many design challenges that must be considered when using AM. For example, overhangs can be difficult to incorporate into the geometry of the article being manufactured. Overhangs are abrupt changes in an article's geometry. Since AM creates an article by adding layers of melted or semi-melted material on top of previously laid layers of material, it can be difficult to produce a design where material protrudes over or extends beyond existing layers of material. For example, using AM to create a dome, overhang, threads, and/or a bridge geometry can be extremely challenging and lead to build failures, such as collapse of the overhanging feature.

Fortunately, there are some methods that can be utilized to print challenging geometries. For example, self-supporting overhangs can be utilized to build angled overhangs. Generally, as long as the feature's angle relative to the build plate is 45 degrees or greater, the material will not collapse. For overhangs with angles that are below 45 degrees, support structures can be printed with the article to support the overhang. These support structures can be removed after the material has hardened and solidified. Additionally, overhangs with angles that are below 45 degrees can be printed over a scaffold to support the overhang during AM.

However, the use of support structures is not favored because it leads to extra time and materials to build the article and requires extra time to remove the support structures once the article has been fully printed and hardened. Additionally, in many cases, the support structures are printed using a different material than the primary build material, which can lead to a non-ideal surface where the two different surfaces interface. Finally, since the support material typically requires a different material, a second printing nozzle may be required and/or is tied up with only printing the support structure.

Accordingly, it would be desirable to provide articles with self-supporting overhangs with angles below 45 degrees relative to the build plate without support structures. For example, it would be desirable to provide articles with challenging geometries, such as domes, bridges, threads, and/or self-supporting overhangs, angles below 45 degrees relative to the build plate without support structures. It would also be desirable to provide AM techniques that allow for the manufacture of articles with challenging geometries, such as domes, bridges, threads, and/or overhangs, with self-supporting overhangs with angles below 45 degrees relative to the build plate without support structures.

### SUMMARY OF THE INVENTION

Disclosed herein is a preform for producing a blow molded article with an open-ended neck; a body made of one or more polymer roads; and an endcap with one or more polymer roads and a self-supporting overhang at an angle of from about 45° to about 0°.

Also disclosed herein is a preform for producing a blow molded article with an open-ended neck; a body with one or more polymer roads forming a wall of the body; and a closed endcap with one or more polymer roads forming a wall of the endcap, wherein the wall of the body has a thickness which is a whole number multiple of a road width of the one or more polymer roads of the body.

Also disclosed herein is a preform for producing a blow molded article with an open-ended neck with a wall of the neck that has a thickness of from about 1 mm to about 3 mm; a body with a wall of the body that has a thickness of from about 2 mm to about 6 mm; and a closed endcap with a wall of the endcap that has a thickness of from about 2 mm to about 6 mm and an overhang at a self-supporting angle of from less than 45° to about 15°.

Also disclosed herein is a blow molded article produced from the preforms described herein.

Also disclosed herein is a method for manufacturing a blow molded article comprising: (a) Providing a digital description of a three-dimensional preform, (b) Depositing concentrically filled polymer roads to satisfy a first layer of digital description, (c) Incrementally depositing successive layers on top of the first layer to generate the preform, and (d) Forming a blow molded article from the preform using a blow molding process.

### BRIEF DESCRIPTION OF THE DRAWINGS

FIG. 1 is a perspective view of a preform on a build plate.

FIG. 2 is a cross-sectional view of the preform of FIG. 1 taken through section line 2.

FIG. 2A is a magnified view of a portion of the wall of the body of the preform shown in FIG. 2.

FIG. 2B is a magnified view of a portion of the wall of the neck of the preform shown in FIG. 2.

FIG. 2C is a magnified view of a portion of the wall of the endcap of the preform shown in FIG. 2.

FIG. 3 is a cross-sectional view of a the preform of FIG. 1 taken through section line 3.

FIG. 4 is a cross-sectional view of exemplary blow molding equipment that could be used to make a blow molded article from a preform.

FIG. 5 is a printed preform (left) and a blow molded article (right) formed from a printed preform.

### DETAILED DESCRIPTION OF THE INVENTION

While articles have been previously created through AM and 3D printing techniques with overhanging geometries, such as domes, threads, and bridges, these typically are limited by physical characteristics to minimize the potential for material collapse. The present invention is directed to methods of making via AM articles comprising overhangs without support structures. Additionally, the present invention is directed to articles with self-supporting overhangs and challenging geometries, such as domes, bridges, threads, and/or overhangs, and AM methods of making said articles without support structures.

Typically, self-supporting overhangs can only be 45 degrees or greater with respect to the build plate. However, it has been unexpectedly found that depending on the specific geometry of the printed article and the printing parameters, structures can be formed with self-supporting overhangs with angles less than 45 degrees from the build plate without needing support structures to be printed along with the primary article.

While specific reference is herein to self-supporting overhangs within the design of a preform, bottle, or container, the self-supporting overhangs can be designed into any article manufactured or created with any AM technique.

The foregoing summary is not intended to define every aspect of the invention, and additional aspects are described in other sections. In addition, the invention includes, as an additional aspect, all embodiments of the invention narrower in scope in any way than the variations defined by specific paragraphs set forth herein. For example, certain aspects of the invention that are described as a genus, and it should be understood that every member of a genus is, individually, an aspect of the invention. Also, aspects described as a genus or selecting a member of a genus should be understood to embrace combinations of two or more members of the genus. With respect to aspects of the invention described or claimed with “a” or “an,” it should be understood that these terms mean “one or more” unless context unambiguously requires a more restricted meaning. The term “or” should be understood to encompass items in the alternative or together, unless context unambiguously requires otherwise. If aspects of the invention are described as “comprising” a feature, embodiments also are contemplated “consisting of” or “consisting essentially of” the feature.

As used herein, a “road” is understood to describe at least a partially continuous or a continuous stream of material that has been extruded out of the nozzle of a 3D printer. A single layer of a 3D printed article can comprise many roads of material in a variety of orientations, such as concentric or linear. While specific reference is provided herein to “polymer roads,” the roads can be made of any material that can be extruded out of a nozzle through additive manufacturing techniques.

As used herein, a “digital voxel” is understood to describe a value on a regular grid in three-dimensional space of a particular portion of an object. Thus, a digital description of the object to be created or manipulated by AM can comprise a set of voxels created by and/or inputted into computer aided design software.

As used herein, a “printed voxel” is understood to describe a single volume of material extruded out of the nozzle of a 3D printer or other AM equipment corresponding to a digital voxel in a digital description of an article. Printed voxels can be deposited as polymer roads.

As used herein, “concentric” is understood to describe a series of shapes sharing a common center, with smaller shapes nesting inside larger shapes. The concentric shape can be any polygon, such as, for example, a circle, an oval, a triangle, a square, a pentagon, hexagon, or octagon.

As used herein, “concentric infill” is understood to describe an infill pattern used to create an object using AM where the roads of material are printed from the exterior and interior surface of the object. The infill is then printed from the exterior surface towards the interior surface in concentric shapes or the infill is printed from the interior surface towards the exterior surface in concentric shapes.

As used herein, “linear infill” is understood to describe an infill pattern where the roads of polymer are first printed in the shape of the exterior surface and interior surface of the object. Then, the space between the exterior surface and interior surface of the object is filled by printing roads of polymer in straight or substantially straight lines.

As used herein, a “preform” is understood to describe a precursor to a finished article. For example, for a blow molded article, the preform is the precursor article that is formed of the material that will be expanded or “blown” into the finished article. A preform is necessarily somewhat smaller than the finished blown article. Preforms are generally produced by, for example injection molding, at an elevated temperature in excess of the melt temperature of the material from which they are made. However, a new method for producing a preform, via additive manufacturing, is disclosed herein.

As used herein, the term “blow molding” as used herein is the process in which preforms are heated above their glass transition temperature, and then expanded in molds using a pressurized medium, preferably air, to form hollow articles, such as containers. Often, the preform is stretched with a stretch rod as part of the process.

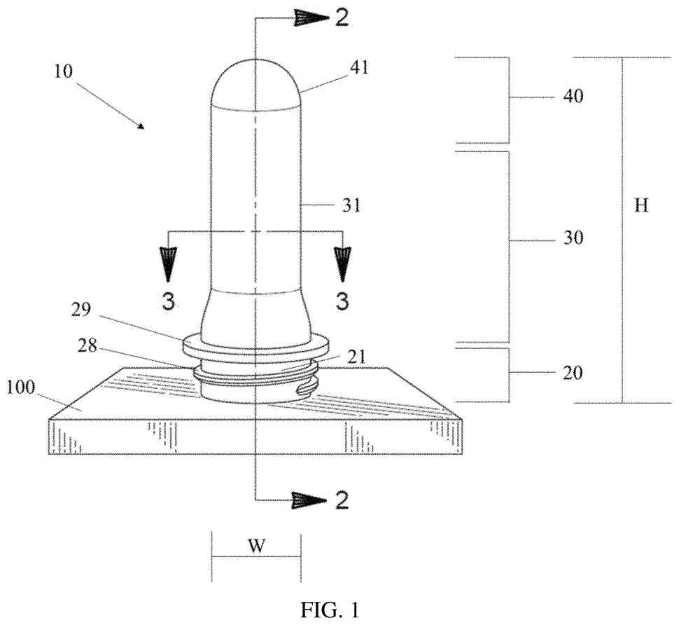

As used herein, the “z-axis” is the longitudinal axis (or centerline of the article), as in FIG. 1.

As used herein, the “x-y plane” is the plane substantially perpendicular to the z-axis.

Features of the compositions and methods are described below. Section headings are for convenience of reading and not intended to be limiting per se. The entire document is intended to be related as a unified disclosure, and it should be understood that all combinations of features described herein are contemplated, even if the combination of features is not found together in the same sentence, or paragraph, or section of this document. It will be understood that any feature of the methods or compounds described herein can be deleted, combined with, or substituted for, in whole or part, any other feature described herein.

All measurements referred to herein are made at 25° C. unless otherwise specified.

The components of the present compositions and methods are described in the following paragraphs. The FIGURES are intended to be non-limiting examples and represent possible embodiments of the container and methods of use of the container disclosed herein.

### Preform

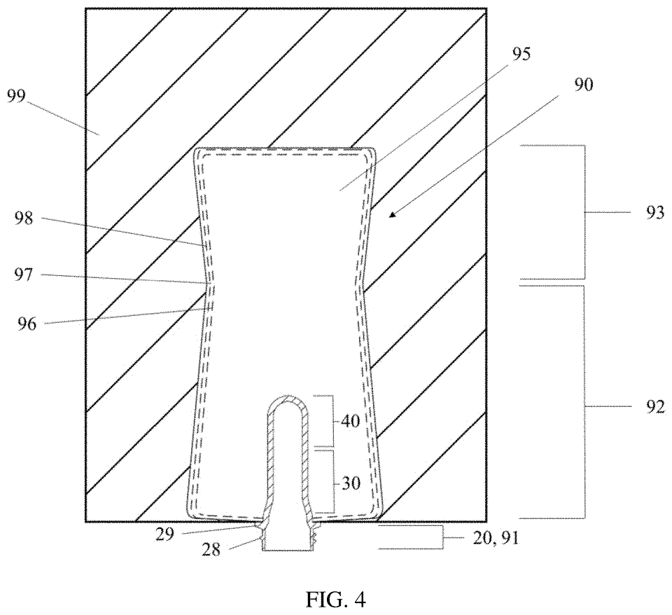

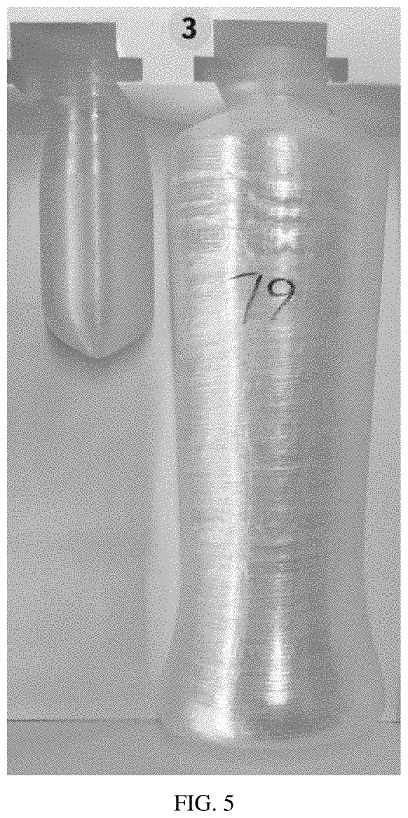

FIG. 1 shows an example of a preform in accordance with the present invention. The preform (10) of the present invention can comprise a neck (20), a body (30), and an endcap (40). Each portion of the preform (10) is named for the final portion it corresponds to in the final blow molded article (90), as in FIG. 4. The neck (20), body (30), and endcap (40) neck (20) can be created as a single, continuous article through an AM technique or the body (30) and endcap (40) can be laid on top of an injection molded neck (20) through an AM technique. FIG. 5 shows an example of a preform (10) and a blow molded article (90) in accordance with the present invention

### Neck

As in FIG. 1, the neck (20) can be the portion of the preform (10) that ultimately ends up being the neck (91) of the blow molded article (90), as in FIG. 4. As shown in FIG. 1, the neck (20) of the preform (10) can be associated with the body (30) of the preform (10). The neck (20) of the preform (10) can be a unitary piece, but may include separate non-structural elements, such as labels, grip structures, threads (28), a lid, a ledge (29) for the lid to rest, etc. associated with the exterior surface (21) of the preform (10). The neck (20) can comprise different regions of different materials, which are intrinsically bonded, chemically bonded, or otherwise associated with one another as a part of the manufacturing process.

The neck's (20) cross-sectional shape can be circular, rectangular, cylindrical, oval, triangular, polygonal, or any other desired shape. The neck's (20) cross-sectional shape can vary or be essentially consistent along the latitudinal axis, as shown in FIG. 1.

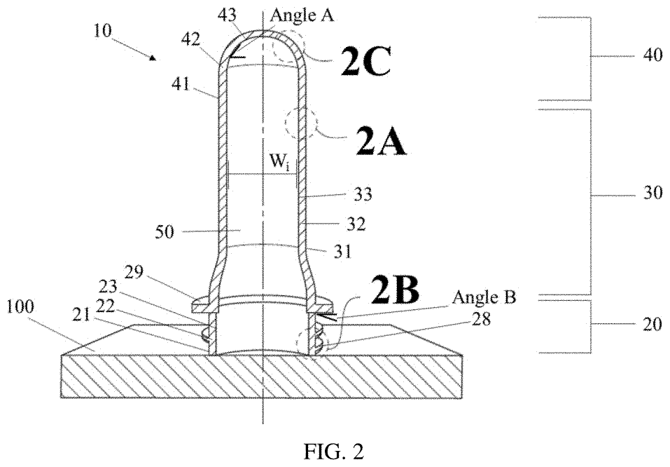

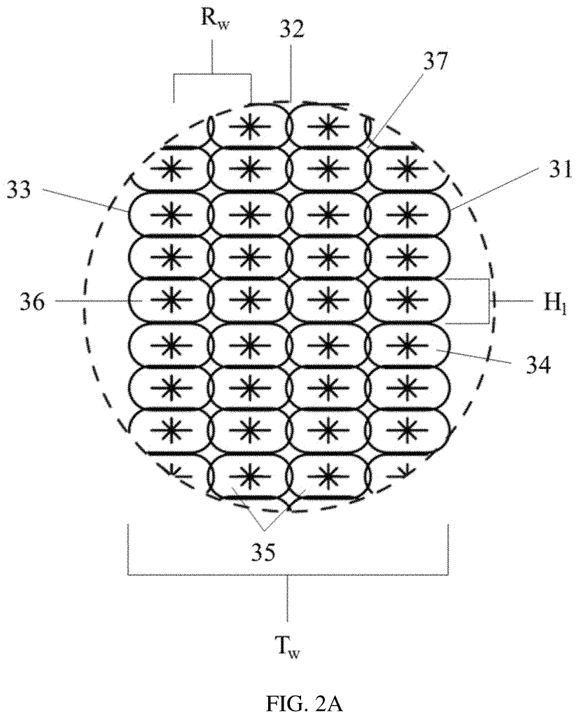

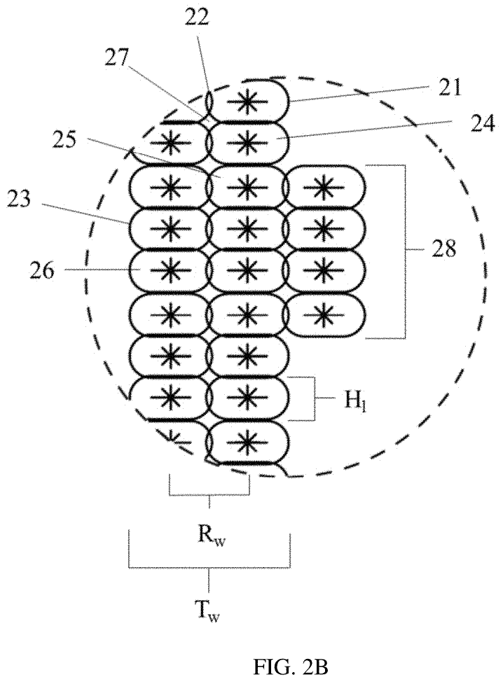

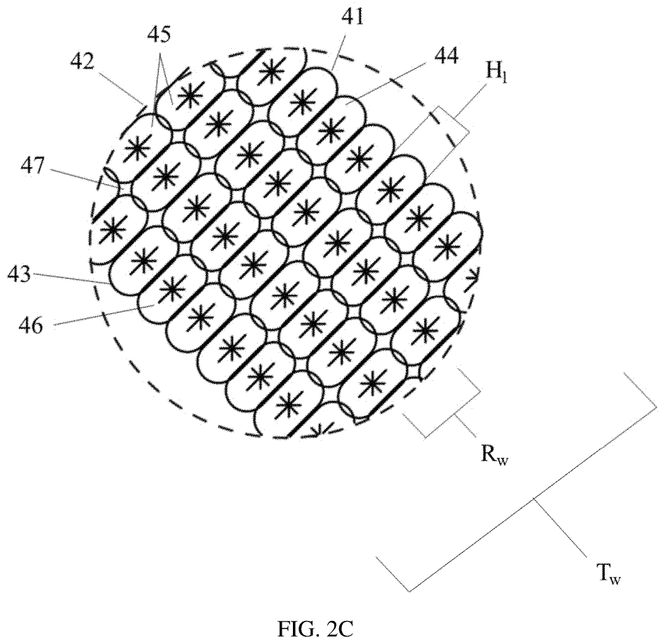

As shown in FIG. 2, the neck (20) can comprise a wall (22) of the neck (20). The wall (22) of the neck (20) can have an exterior surface (21) and an interior surface (23). The neck (20) can be at least partially open or open, for example, such that a compressed gas can be injected into the preform (10) during the blow molding process to create a blow molded article. The neck (20) can be at least partially open or open so that the blow molded article (90) can be filled with a variety of solid, liquid, aqueous, or combinations thereof components through the neck (91) of the blow molded article (90). As shown in FIG. 2, the void created by the interior surface (23) of the neck (20), the interior surface (33) of the body (30), and the interior surface (43) of the endcap (40) can form the interior portion (50) of the preform (10), and ultimately, after for example, a blow molding process, the interior portion (95) of the blow molded article (90).

As shown in FIG. 2B, the neck (20) can comprise an exterior polymer road (24) and an interior polymer road (26) that surround at least a portion of the perimeter of the preform (10). The exterior polymer road (24) and an interior polymer road (26) can be concentric, with the interior polymer road (26) disposed inside of the exterior polymer road (24), i.e. towards the center of the preform (10). As shown in FIG. 2B, the neck (20) can comprise one or more wall polymer roads (25) that are placed between the interior polymer road (26) and the exterior polymer road (24). The one or more wall polymer roads (25) can be concentric with the interior polymer road (26) and the exterior polymer road (24), such that the interior polymer road (26) resides inside the wall polymer road (25) and the wall polymer road (25) resides inside the exterior polymer road (24).

As in FIG. 2B, the threads (28) of the neck (20) can be a single polymer road. However, the threads (28) of the neck (20) can comprise at least a portion of polymer road, such that the polymer road partially overlaps the exterior polymer road (24) of the previously deposited layer.

The wall (22) of the neck (20) can comprise any suitable number of wall polymer roads (25). For example, the wall (22) of the neck (20) may comprise from greater than 0 to 10, from greater than 0 to 5, or from greater than 0 to 3 of the wall polymer roads (25). In total, the wall (22) of the neck (20) can comprise from 2 to 12, from 2 to 7, or from 2 to 5 polymer roads, which include the interior polymer road (26), the exterior polymer road (24), and the wall polymer road (25). Alternatively, the wall (22) of the neck (20) can have zero wall polymer roads (25), such that the wall (22) of the neck (20), only has an exterior polymer road (24) and an interior polymer road (26).

As in FIG. 2B, the wall (22) if the neck (20) can have a consistent thickness throughout, such as, for example, exactly 2 or exactly 4 polymer roads, or the wall (22) of the neck (20) can vary in thickness, such as, for example, 2 polymer road thickness in some portions of the wall (22) and 4 polymer roads in some portions of the wall (22).

The thickness, T_{w} in FIG. 2B, of the wall (22) of the neck (20) can be from about 0.5 mm to about 20 mm, from about 1 mm to about 20 mm, from about 1 mm to about 10 mm, from about 1 mm to about 3 mm, from about 2 mm to about 6 mm, or from about 2 mm to about 5 mm. As in FIG. 2B, the thickness of the wall (22) of the neck (20) can be a whole number multiple of the thickness of an individual wall polymer road (25) or the road width, R_{w} in FIG. 2B.

### Body

As shown in FIG. 1 the body (30) can be the portion of the preform (10) that ultimately ends up being the body (92) of the blow molded article (90), as in FIG. 4. The body (30) of the preform (10) can be associated with the neck (20) of the preform (10) and the endcap (40) of the preform (10).

The body (30) of the preform (10) can be a unitary piece, but may include separate non-structural elements, such as label panels, grip structures, etc. associated with the exterior surface (31) of the preform (10). The body (30) can comprise different regions of different materials, which are intrinsically bonded, chemically bonded, or otherwise associated with one another as a part of the manufacturing process.

The body's (30) cross-sectional shape can be circular, rectangular, cylindrical, oval, triangular, polygonal, or any other desired shape. The body's (30) cross-sectional shape can vary or be essentially consistent along the latitudinal axis, as shown in FIG. 1.

As shown in FIG. 2, the body (30) can comprise a wall (32) of the body (30). The wall (32) of the body (30) can have an exterior surface (31) and an interior surface (33). The body (30) can be at least partially open or open, such that a compressed gas can be injected through the neck (20) and the body (30) during the blow molding process to create a blow molded article (90). The body (30) can be at least partially open or open so that the blow molded article (90) can be filled with a variety of solid, liquid, aqueous, or combinations thereof components through the neck (91) of the blow molded article (90). The void created by the interior surface (23) of the neck (20), the interior surface (33) of the body (30), and the interior surface (43) of the endcap (40) can form the interior portion (50) of the preform (10), and ultimately, after a blow molding process, the interior portion (95) of the blow molded article (90).

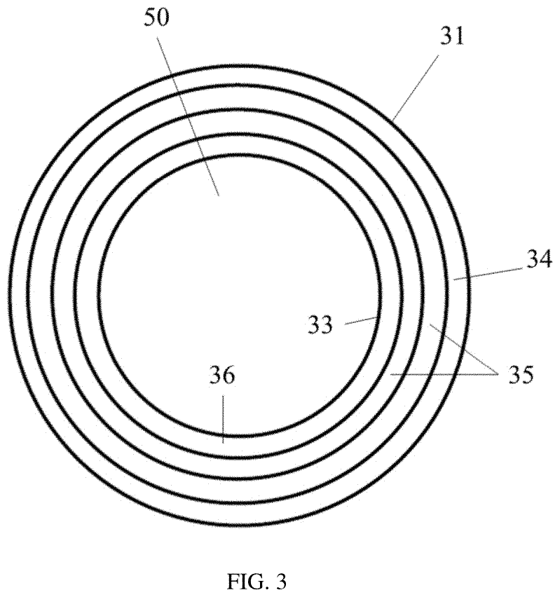

As shown in FIGS. 2A and 3, the body (30) can comprise an exterior polymer road (34) and an interior polymer road (36) that surround at least a portion of the perimeter of the preform (10). The exterior polymer road (34) and an interior polymer road (36) can be concentric, with the interior polymer road (36) residing inside the exterior polymer road (34), i.e. towards the interior of the preform (10). The body (30) can comprise one or more wall polymer roads (35) that are placed between the interior polymer road (36) and the exterior polymer road (34). As in FIG. 3, the wall polymer road (35) can be concentric with the interior polymer road (36) and the exterior polymer road (34), such that the interior polymer road (36) resides in the wall polymer road (35) and the wall polymer road (35) resides inside the exterior polymer road (34).

The wall (32) of the body (30) can comprise any suitable number of wall polymer roads (35). For example, the wall (32) of the body (30) may comprise from greater than 0 to 10, from greater than 0 to 5, or from greater than 0 to 3 of the wall polymer roads (35). In total, the wall (32) of the body (30) can comprise from 2 to 12, from 2 to 7, or from 2 to 5 polymer roads, which include the interior polymer road (36), the exterior polymer road (34), and the wall polymer road (35). Alternatively, the wall (32) of the body (30) can have zero wall polymer roads (35), such that the wall (32) of the body (30), only has an exterior polymer road (34) and an interior polymer road (36).

As in FIG. 2A, the wall (32) of the body (30) can have a consistent thickness throughout, such as, for example, exactly 2 or exactly 4 polymer roads, or the wall (32) of the body (30) can vary in thickness, such as, for example, 2 polymer road thickness in some portions of the wall (32) and 4 polymer roads in some portions of the wall (32).

The thickness, T_{w} in FIG. 2A, of the wall (32) of body (30) can be from about 0.5 mm to about 20 mm, from about 1 mm to about 20 mm, from about 1 mm to about 10 mm, from about 1 mm to about 3 mm, from about 2 mm to about 6 mm, from about 2 mm to about 5 mm, or from about 3 mm to about 8 mm. The thickness, T_{w} in FIG. 2A, of the wall (32) of body (30) can be greater than about 2 mm, greater than about 2.5 mm, or greater than about 2.75 mm. As in FIG. 2A, the thickness, T_{w} in FIG. 2A, of the wall (32) of the body (30) can be a whole number multiple of the thickness of an individual wall polymer road (35) or the road width, R_{w} in FIG. 2A.

### Endcap

As shown in FIG. 1, the endcap (40) can be the portion of the preform (10) that ultimately ends up being the base (93) of the blow molded article (90), as in FIG. 4. The endcap (40) of the preform (10) can be associated with the body (30) of the preform (10). The endcap (40) of the preform (10) can be a unitary piece, but may include separate non-structural elements, such as label panels, grip structures, etc associated with the exterior surface (41) of the preform (10). The endcap (40) can comprise different regions of different materials, which are intrinsically bonded, chemically bonded, or otherwise associated with one another as a part of the manufacturing process.

The endcap's (40) cross-sectional shape can be circular, rectangular, cylindrical, oval, triangular, polygonal, or any other desired shape. The endcap's (40) cross-sectional shape can vary or be essentially consistent along the latitudinal axis, as shown in FIG. 1.

As shown in FIG. 2, the endcap (40) can comprise a wall (42) of the endcap (40). The wall (42) of the endcap (40) can have an exterior surface (41) and an interior surface (43). The endcap (40) can be at least partially closed or closed, such that a compressed gas can be injected through the neck (20) and the body (30), but remains in the interior space (50) of the preform (10) during the blow molding process to create a blow molded article (90). The endcap (40) can be at least partially closed or closed so that the blow molded article (90) can be filled with a variety of solid, liquid, aqueous, or combinations thereof components through the neck (91) of the blow molded article (90). The void created by the interior surface (23) of the neck (20), the interior surface (33) of the body (30), and the interior surface (43) of the endcap (40) can form the interior portion (50) of the preform (10), and ultimately, after a subsequent process, the interior portion (95) of the blow molded article (90).

As shown in FIG. 2C, the endcap (40) can comprise an exterior polymer road (44) and an interior polymer road (46) that surround at least a portion of the perimeter of the preform (10). The exterior polymer road (44) and an interior polymer road (46) can be concentric, with the interior polymer road (46) residing inside the exterior polymer road (44), i.e. towards the interior of the preform (10). The endcap (40) can comprise one or more wall polymer roads (45) that are placed between the interior polymer road (346) and the exterior polymer road (44).

The wall (42) of the endcap (40) can comprise any suitable number of wall polymer roads (45). For example, the wall (42) of the endcap (40) may comprise from greater than 0 to 10, from greater than 0 to 5, or from greater than 0 to 3 of the wall polymer roads (45). In total, the wall (42) of the body (40) can comprise from 2 to 12, from 2 to 7, or from 2 to 5 polymer roads, which include the interior polymer road (46), the exterior polymer road (44), and the wall polymer road (45). Alternatively, the wall (42) of the endcap (40) can have zero wall polymer roads (45), such that the wall (42) of the endcap (40), only has an exterior polymer road (44) and an interior polymer road (46).

The wall (42) of the endcap (40) can have a consistent thickness throughout, such as, for example, exactly 2 or exactly 4 polymer roads, or the wall (42) of the endcap (40) can vary in thickness, such as, for example, 2 polymer road thickness in some portions of the wall (42) and 4 polymer roads in some portions of the wall (42).

The thickness, T_{w} in FIG. 2C, of the wall (42) of endcap (40) can be from about 0.5 mm to about 20 mm, from about 1 mm to about 20 mm, from about 1 mm to about 10 mm, from about 1 mm to about 3 mm, from about 2 mm to about 6 mm, or from about 2 mm to about 5 mm. The thickness, T_{w} in FIG. 2C, of the wall (42) of endcap (40) can be greater than about 2 mm, greater than about 2.5 mm, or greater than about 2.75 mm. The thickness, T_{w} in FIG. 2C, of the wall (42) of the endcap (40) can be a whole number multiple of the thickness of an individual wall polymer road (45) or the road width, R_{w} in FIG. 2C.

### Dimensions of the Preform

The dimensions of the preform (10) can be any suitable dimensions to provide the user with the desired finished article. For example, the total height, H, as shown in FIG. 1, of the preform (10) can be from about 10 mm to about 500 mm, from about 20 mm to about 250 mm, or from about 40 mm to about 125 mm. The total width, W, as shown in FIG. 1, of the preform (10) can be from about 1 mm to about 1 m, from about 5 mm to about 100 mm, from about 10 mm to about 30 mm, or from about 10 mm to about 20 mm. The total width, W, as shown in FIG. 2, the interior portion (50) of the preform (10) can be from about 1 mm to about 100 mm, from about 10 mm to about 50 mm, or from about 15 mm to about 35 mm.

### Polymer Roads

The polymer roads (24, 25, 26, 34, 35, 36, 44, 45, 46) can comprise at least a partially continuous or a continuous stream of printed voxels corresponding to a set of digital voxels in a digital description of the preform (10). The digital description of the preform (10) can be in the form of a computer assisted design, such as for example, a CAD file.

The polymer roads (24-26, 34-36, and/or 44-46) can comprise one or more materials. Non-limiting examples include polymers, including those that are naturally sourced, synthetic polymers, and combinations thereof. Non-limiting examples of naturally sourced polymers can include alginates, gums, protein based polymers, starch based polymers, native starches, modified starches, fiber polymers, other naturally sourced polymers, and combinations thereof. Non-limiting examples of synthetic polymers can include polyolefin resins, such as polyethylene (PE) and polypropylene (PP), acrylates, such as poly methyl acrylate (PMA), carbonates, such as polycarbonate (PC), methacrylates, such as poly methyl methacrylate (PMMA), amides such as Nylon 6: Acetal, copolymers, such as acrylonitrile butadiene styrene (ABS), chlorinated polymers, such as polyvinyl chloride (PVC), styrenics, such as Polystyrene (PS), esters, such as polyethylene terephthalate (PET), modified esters such as PETG, polyformaldehyde such as Delrin, and/or mixtures thereof.

The polymer roads (24-26, 34-36, 44-46) can be any shape that can be extruded out of the nozzle of a 3D printer, such as, for example, substantially shaped as a cylinder, rectangular prism, triangular prism, or pentagonal prism. The polymer roads (24-26, 34-36, 44-46) can have straight or rounded edges and/or corners.

The one or more materials can comprise a reheat additive. A reheat additive is an additive capable of improving the reheat characteristics of a polymer or polymeric composition. Such reheat additives include, for example, LaB₆, carbon black, graphite, antimony metal, black iron oxide, red iron oxide, inert iron compounds, spinel pigments, infrared-absorbing dyes, tungsten oxides, antimony tin oxide (ATO), tungsten bronzes, titanium nitride, and other suitable reheat additives. The reheat additives can be nano-sized to minimize impact on clarity of the blow molded article.

The diameter of the polymer roads (24-26, 34-36, 44-46), or road width (R_{w}) can be any suitable size, including, for example, from about 0.1 mm to about 10 mm, from about 0.5 mm to about 5 mm, or from about 0.6 to about 1.5 mm as measured by the diameter of the extrusion nozzle.

It may be desirable to minimize the spacing between polymer roads (24-26, 34-36, 44-46) in the same layer and the spacing between successive layers of polymer roads (24-26, 34-36, 44-46) to prevent or minimize gaps, or void space (27, 37, 47), as in FIGS. 2A, 2B, and 2C, that can disrupt the blow molding process. Thus, the spacing between the polymer roads (24-26, 34-36, 44-46) in the same layer can be defined by the road width, R_{w}. The spacing between the polymer roads in the same layer (24-26, 34-36, 44-46) can be determined the distance between the centers of two adjacent deposited polymer roads (24-26, 34-36, 44-46), such as the difference between the center of an interior polymer road (24) and a wall polymer road (25), and the diameter of the extruded material, which can be approximated by the size of the nozzle used. When the road width is smaller than the diameter of the extruded material, the two concentric polymer roads will slightly overlap to minimize any void space. The spacing between the polymer roads (24-26, 34-36, 44-46) in the same layer can be from about 0 mm to about 10 mm, from about 0.25 mm to about 2 mm, or from about 0.5 mm to about 1 mm. The road width can be smaller, equal to, or larger than the diameter of the polymer road.

The spacing between the polymer roads (24-26, 34-36, 44-46) in different layers can be defined by the layer height, Hi as shown in FIGS. 2A-2C. The layer height can be from 0 mm to about 10 mm, from 0 mm to about 0.1 mm, from 0.01 mm to about 0.05 mm, from 0.01 mm to about 0.04 mm, or from about 0.01 mm to about 0.03 mm.

### Preform Design

In some cases, such as in the printing of overhangs, enclosed endcaps, and/or threads (28), the printed article can collapse without adequate support. The printed article's geometry can be designed such that overhangs are supported with a printed feature, such as scaffolding, that can be removed after cessation of the AM process. However, the process to manually remove such printed support features can be time intensive and a waste of material. Alternatively, the overhangs can be designed to begin gradually, such that the overhang is self-supporting and requires no other supporting features to prevent collapse of the feature.

The preform (10) can have self-supporting overhanging polymer roads. For example, as shown in FIG. 2, Angle A is the angle of the self-supporting overhang corresponding the endcap (40) of the preform (10). Angle A is the angle created by the inner surface (43) of wall (42) of the endcap (40) with respect to the build plate (100) of the 3D printer or cross-section line 3 of the preform (10) as depicted in FIG. 1. Angle B is the angle of the self-supporting overhang corresponding to the ledge (29) of the neck (20) with respect to the build plate (100) of the 3D printer or cross-section line 3 of the preform (10) as depicted in FIG. 1

The self-supporting overhangs can be described by the angle between an overhanging feature of the preform (10) and the build plate (100), as shown in FIG. 2. The self-supporting angle can be less than about 45°, less than about 40°, less than about 35°, or less than about 30°. The self-supporting angle can be from about 45° to about 0°, from about 45° to about 15°, from about 40° to about 20°, from about 35° to about 15°, less than 45° to about 0°, less than 45° to about 15°, or less than 45° to about 20°.

Surprisingly, the dimensions of a preform (10) made by AM can be different from the dimensions of a preform created by injection molding even though the end weight of the blow molded article can be kept about the same. Thus, the weight of the preform (10) can be consistent with a preform created by injection molding. However, the overall length of the preform (10) and the exact wall thickness can be modified to generate a preform (10) capable of surviving the blow molding process. For example, the preform (10) can have a shorter total height, H, but a greater wall (32) of the body (30) thickness, T_{w}, than an injection molded preform, but retain the same overall weight.

Additionally, the preform (10) can be printed with its widest portion adjacent to or associated with the build plate (100) of the 3D printer. The neck (20) of the preform (10) can be printed facing the build plate (100) of the 3D printer. The widest portion can be adjacent to or associated with the build plate (100) of the 3D printer to provide a base for the remaining portions of the preform (10) to reside on. This type of design can minimize overhangs when printing.

### 3D Printing Method

For 3D printing, a digital description of the article to be manufactured may be translated to the article, such as, for example, a preform (10), by the creation of an actual set of voxels corresponding to the set of voxels in the digital representation. This translation may be accomplished using known AM techniques including material extrusion techniques, and those techniques referred to as 3D printing, or three-dimensional printing techniques. The digital description can be in any digital format, such as, for example, a CAD file.

The digital voxels can be transformed into printed voxels in the shape of polymer roads (24-26, 34-36, 44-46) by any known means such as 3D printing. When 3D printed, for example, material forming the roads can be deposited into a two dimensional layer along the x-y plane with respect to the build plate (100) in any sequence, such as a linear, concentric, grid, triangular, tri-hexagonal, cubic, cubic subdivision, octet, quarter cubic, concentric 3D, zig zag, cross, cross 3D infill, spiral, any 2D pattern that fills the area between the interior road and exterior road linear to the x-y plane, and/or any 2D pattern that fills the area between the interior road and exterior road concentric to the 2D shape of the interior and exterior roads.

Once the digital representation of the object to be printed is loaded into a system capable of instructing hardware to undergo AM techniques, the hardware's parameters can be manipulated to affect the properties of the created item.

The nozzle and/or build-platform can move to allow for at least three dimensions of orthogonal motion relative to one another. Polymer roads can be deposited to form a two-dimensional layer and then another layer of fluid material is deposited over the preceding layer to form the three-dimensional object. The liquid droplet size and the distance between the dispensing nozzle and the proceeding layer control the printed voxel size and thus, the diameter or surface area of the polymer roads (24-26, 34-36, 44-46), as described herein.

Material for extrusion through the nozzle (“build materials”) may be in any form, such as, for example, a filament, pellet, powder or liquid form. A plurality of build materials may be used. The build-platform, nozzle and any liquid reservoir can temperature controlled. A fan or air jets may be used to aid in cooling of extruded material. The final object may be post processed using any known methods including sanding, polishing and steaming to improve surface finish.

Each printed voxel that collectively creates with other printed voxels one or more polymer roads (24-26, 34-36, 44-46) can comprise one or more materials, including polymers. Non-limiting examples of polymers can include naturally sourced polymers, synthetic polymers, and combinations thereof. Each printed voxel that collectively creates one or more polymer roads (24-26, 34-36, 44-46) can comprise the same or different polymer composition as the other printed voxels.

Each printed voxel that collectively creates a polymer road (24-26, 34-36, 44-46) can have a variable size. Thus, the printed voxel size can be manipulated, such that a polymer road (24-26, 34-36, 44-46) can comprise printed voxels of varying dimensions. The dimensions of the printed voxel can be manipulated by changing the corresponding digital voxels or by modifying the printing parameters.

Each printed voxel that collectively creates a polymer road (24-26, 34-36, 44-46) can comprise one or more polymers with color concentrates and/or color additives. Suitable color concentrates are pigments and dyes. Suitable organic color concentrates include, for example, Cu-Phthalocyanine, Anthraquinone, Dioxazine, and Benzimidazolone. Suitable inorganic color concentrates include, for example, titanium dioxide, ultramarine, iron oxide, carbon black and pearl, and other metal pigments. Suitable additives include, for example, dispersing aides, antioxidants, fillers, slip promoters, UV absorbers, anti-static agents, nucleating agents, anti-blocking agents, and flame retardants.

Each printed voxel that collectively creates one or more polymer roads (24-26, 34-36, 44-46) can comprise the same or different pigment or dye as the remaining printed voxels. Collectively, this can allow for a preform (10) comprising roads and layers with unique color combinations that can allow for designs to be printed into the walls (22, 32, and 42) of the preform (10). Additionally, the design can be printed into the walls (22, 32, and 42) of the preform (10) such that the design to become apparent after blow molding the preform (10) into the blow molded article (90) as described herein. Some designs that can be printed in the preform (10) by altering the printed voxel color composition include, for example, graphics, logos, phrases, words, directions, warnings, labels, artwork, shapes, characters, or any other descriptive, marketing, or product identifying material.

The digital description of the preform (10) can be translated into an actual object through the use of 3D printing software. A variety of printing parameters can be manipulated, such as the geometry of the preform (10), the type, size, and number of nozzle(s) on the 3D printer or AM machine, the layer height, the number of roads of polymers (24-26, 34-36, 44-46), the infill density, the printing temperature, the build plate temperature, the filament flow, the filament retraction distance, the filament retraction speed, the print speed, the print head travel speed, the initial layer speed, the printhead travel acceleration, the fan speed, the build plate adhesion type, among others.

Additionally, an optimized material setting can prepopulate at least a portion of the printing parameters. Such optimized material settings include, for example, PE, CPE, PET, PP, PLA, and other preselected material settings.

The 3D printer can have at least one nozzle, one or more nozzles, one nozzle, two nozzles, less than three nozzles, three nozzles or four nozzles. The 3D printer extrudes a continuous stream of printed voxels in the form of filaments through one or more nozzles. The same composition of printed voxels can be extruded out of multiple nozzles or each nozzle can extrude a different composition of printed voxels.

The layer height, or Hi in FIG. 2A-C, is the distance the build plate (100) is lowered (in the z direction) between each layer of printed material. Adjustment of the layer height can affect the volume of the void present between each layer of printed material. The layer height can be from about 0 mm to about 10 mm, from 0 mm to about 1 mm, from 0.1 mm to about 0.5 mm, from 0.1 mm to about 0.4 mm, or from about 0.1 mm to about 0.3 mm.

The thickness of the preform (10) is controlled by altering the number of polymer roads (24-26, 34-36, 44-46) as described previously. The thickness of the preform (10) can vary or be essentially consistent. The thickness of the preform (10) can vary to create grip structures, threads (28), a lid, a ledge (29) for the lid to rest, etc. associated with any of the exterior surfaces (21, 31, or 41) or interiors surfaces (23, 33, or 43) of the preform (10).

The infill density is the amount of polymer to be filled between the outer layers and inner layers of the preform (10). The infill density can be at least about 50%, at least about 75%, at least about 90%, or about 100%. The infill density can be from 0% to about 100%.

The printing temperature is the temperature at the nozzle. The printing temperature can be the same for all printed layers or the printing temperature can vary from layer to layer. The printing temperature can be a particular temperature for the initial layer printed and a different printing temperature for the remaining layers. The printing temperature can be any suitable temperature for the material used and the desired end result. The printing temperature can be a function of the selected material, and can be above the melting temperature for the selected material. For example, the printing temperature may be from about 150° C. to about 300° C., from about 175° C. to about 275° C., from about 200° C. to about 250° C., or from about 200° C. to about 225° C.

The build plate temperature is the temperature at the build plate (100), where the printed article rests during printing. The build plate temperature can be the same during the entire printing process or the build plate temperature can vary during the printing of any layer. The build plate temperature can be a particular temperature when initial layer is printed and a different build plate temperature for the remaining layers to aid in the initial adhesion of the printed article to the build plate (100). The build plate temperature can be a function of the selected material. The build plate temperature can be below the melting temperature of the selected material. The build plate temperature can be from about 20° C. to about 300° C., from about 50° C. to about 200° C., from about 50° C. to about 150° C., or from about 75° C. to about 125° C.

Filament flow is the quantity or volume of filament that passes through the nozzle based on the selected parameters. The filament flow can be from about 75% to about 125%, from about 80% to about 115%, or from about 90% to about 110%.

Between each printed layer, the filament, or polymer road, can be retracted while the nozzle is repositioned. The filament can be retracted to prevent loss of material or excess material inadvertently falling on unintended areas of the preform (10). The filament retraction distance is how far the filament, or polymer road, can be retracted from the tip of the nozzle. The filament retraction distance can be from about 1 mm to about 25 mm, from about 2 mm to about 15 mm or from about 4 mm to about 10 mm. The filament retraction speed is how fast the filament, or polymer road, is retracted from the tip of the nozzle. The filament retraction speed can be from about 10 mm/s to about 100 mm/s, from about 20 mm/s to about 60 mm/s, or from about 30 mm/s to about 50 mm/s.

The print speed is the speed the print head moves while printing. The print speed when the nozzle is printing an exterior polymer road (24, 34, or 44) can be different when compared with the print speed of an infill polymer road (23, 33, or 43). Additionally, the initial layer print speed can be faster or slower than the remaining layer print speed so that the initial layer may better adhere to the build plate (100). The print speed can be from about 5 mm/s to about 100 mm/s, from about 10 mm/s to about 75 mm/s, from about 15 mm/s to about 50 mm/s, or from about 20 mm/s to about 35 mm/s.

The print head travel acceleration can be changed. A slower print head acceleration will make the print slower, but more accurate. The print head travel acceleration can be from about 2000 mm/s² to about 10000 mm/s², from about 3000 mm/s² to about 8000 mm/s², or from about 4000 mm/s² to about 6000 mm/s².

Once a layer has been printed, the recently printed layer can be cooled prior to printing the next layer in the z direction. The recently printed layer can be cooled with a fan. Higher fan speeds can help reduce cooling time and reduce oozing, but can also increases the shrinkage of the material. This means that the fan speed may be different per material. The fan speed can be from about 0% to about 100%, from about 1% to about 10%, from about 2% to about 8%, or from about 2% to about 5%.

The fan speed for the initial printed layer can the same or different than the other recently printed layers. The fan speed for the initial printed layer can be from about 0% to about 25%, from about 1% to about 10%, from about 2% to about 8%, or from about 2% to about 5%.

Extra cooling jets can be used to increase the cooling rates of the recently printed layer. This can avoid excessive crystallization of the one or more polymers, such as, for example, semi-crystalline polymers like PET.

The distance from the recently printed layer and the fan/jets can be manipulated to affect the cooling of the recently printed layer. The distance between the recently printed layer and the fan can from about 0.5 mm to about 10 mm, from about 1 mm to about 10 mm, from about 2 mm to about 8 mm, or from about 6 mm to about 12 mm.

The initial layer of polymer roads can be printed in the x-y plane directly on top of the build plate (100). The parameters for the initial layer printing can be different from the remaining layers. Once the parameters have been satisfied for the initial layer printing, a subsequent layer is placed directly on top of the initial layer. After the parameters have been satisfied for the subsequent layer, another subsequent layer is placed on top of the subsequent layer. This process can be repeated until the preform (10) has been completely created.

### Blow Molding Method

The preform (10) can be converted into the blow molded article (90) through either stretch blow molding (SBM) or blow molding (BM).

Blow molding is a well-known manufacturing process for the fabrication of plastic articles such as containers, fuel tanks, handles etc. The blow molding process begins with a preform (10), which can be produced by any number of different methods, including injection molding and the method disclosed herein. As in FIG. 4, the preform (10) can be clamped into a mold (99). The preform (10) can be heated to a temperature above the material's glass transition temperature, but below the preform's melt temperature. The temperature can be a function of the selected material. The temperature can be, for example, from about 80° C. to about 175° C., from about 90° C. to about 150° C., from about 100° C. to about 140° C., or from about 110° C. to about 130° C. The preform (10) can be heated from about 1 min to about 20 min, from about 2 min to about 15 min, or from about 5 min to about 10 min. The preform can be heated using any known means, such as a heated oil bath or infrared heat to heat the preform (10) to a uniform temperature.

A pressurized medium, such as, for example, compressed air, nitrogen, argon, or oxygen, can be blown or pumped into the preform (10). The pressure of the medium forces the plastic to match the peripheral geometry of the mold. Once the plastic has cooled, the mold opens up and the blow molded article is ejected. The pressure of the pressurized medium can start at a particular pressure and be altered through the blow molding process. The pressure of the pressurized medium can be any suitable pressure to provide the desired end result. For example, the pressurized medium can be pressurized to a pressure from about 0.1 bar to about 50 bar, from about 0.2 bar to about 25 bar, from about 0.4 bar to about 12 bar, or from about 1 bar to about 6 bar.

SBM is a blow molding method that additionally uses a stretch rod to stretch the preform (10) in the z direction during the blow molding process. The additional stretching experienced with a stretch rod can allow a greater number of polymer molecules to obtain biaxial orientation, than processes that do not use a stretch rod, which can improve the strength of the blow molded article. he stretch rod can be inserted into the preform (10) prior to, during, or after the pressurized medium has been introduced. The stretch rod can be inserted into the preform at a fixed length in the interior (50) of the preform (10). The stretch rod can be used to further stretch the endcap (40) of the preform (10).

The SBM process can include a blow delay. A blow delay is the time after the pressurized medium has been introduced that the stretch rod is introduced. The blow delay is the relative distance between where the stretch rod hits the interior surface (43) of the endcap (40) of the preform (10) (defined as TO) to the final distance the stretch rod travels (defined as T10), to slightly below the bottom of the mold, such as from about 0.1 mm to about 5 mm below the bottom of the mold. The full blow pressure applied in the interior portion (50) of the preform (10) can be delayed to help material positioning closer to the neck bottle. The blow delay can be from about 1% to about 30%, from about 2% to about 20%, or from about 3% to about 10%. A lower pre-blow pressure can be applied prior to TO to avoid that the heated material touches the stretch rod as the stretch rod approaches TO.

### Container

As shown in FIGS. 4 and 5, the blow molded article (90) can be a container or bottle. The blow molded article (90) can be formed from the 3D printed preform (10) after the blow molding process as described herein. The neck (20) can result in the neck (91) of the blow molded article (90). The body (30) can result in the body (92) of the blow molded article (90). The endcap (40) can result in the base (93) of the blow molded article (90). The neck (91), body (92), and base (93) can form a unitary blow molded article (90) with an interior surface (94) and an exterior surface (96). The interior portion (95) of the blow molded article (90) can be the void inside the interior surface (94) of the blow molded article (90).

### EXAMPLES

The following examples further describe and demonstrate embodiments within the scope of the present invention. The examples are given solely for the purpose of illustration and are not to be construed as limitations of the present invention, as many variations thereof are possible without departing from the spirit and scope of the invention. All exemplified amounts are concentrations by weight of the total composition, i.e., wt/wt percentages, unless otherwise specified.

### Example 1-3D Printing of Preforms

Preforms (10) were created by first developing a digital description. The digital description of the preform was drawn in CAD software. The digital description was exported as a CAD (computer assisted design) file and imported into the Ultimaker Cura 3.4.1 (Geldermalsen, The Netherlands) software program. The filament used for 3D printing the preforms was Vertbatim™ (Mitsubishi Chemical, Tokyo, Japan) Polyethylene Terephthalate (PET) with a diameter of 1.75 mm. The 3D printer used was the Ultimaker 3 (Geldermalsen, The Netherlands).

The overall geometry and design of the digital description can be manipulated as described herein and in TABLE 2. The selected digital description was uploaded into the software program for the 3D Printer, Cura.

Parameters for the 3D printing process were manipulated in Cura. As thousands of printing parameters exist, a group of optimized parameters, CPE, was selected to prepopulate a listing of optimized parameters. A variety of build parameters were then manipulated as in TABLE 1. The filament was melted at the printing temperature and fed through the nozzle. The first polymer road of the first layer was extruded from the nozzle using the infill type selected. The exterior polymer road (24, 34, or 44) was extruded and laid first directly on the build plate (100) of the 3D printer. Next, the interior polymer road (22, 32, or 44) was extruded and laid directed on the build plate (100).

When printing using the concentric infill parameter, the next polymer road was laid immediately adjacent (in the x-y plane) and immediately interior (i.e. concentric) to the exterior polymer road (24, 34, or 44). The remaining roads were filled in by laying progressively smaller concentric circles adjacent to the previously printed roads. The distance between the roads was the road width, R_{w}, or the center to center distance between two adjacent roads.

When printing using the linear infill parameter, the second polymer road laid was the interior polymer road (26, 36, or 46). This left a void between the exterior polymer road (24, 34, or 44) and interior polymer road (26, 36, or 46). This void was filled by laying linear polymer roads between the previously printed circular roads.

Once the first layer in the x-y plane was printed, the build plate (100) was lowered by the distance provided in in the layer height row of TABLE 1. The second layer was laid directly on top of the first layer. This process was repeated for the remaining layers to allow for the 3D printer to print along the z axis. The printing was stopped when the complete preform had been printed.

### Example 2—Stretch Blow Molding of Printed Preforms

3D printed preforms were blown into blow molded articles through a stretch blow molding process. The ability to create a blow molded article from a 3D printed preform was assessed by stretching the preforms using a PET bottle blower (Model No. SB6, Voehringer Engineering, Kornbergstrasse, Lichtenstein) with a 18-20 bar blowing capability. Routine optimization of stretch parameters for each 3D printed preform was conducted in order to produce the best bottle. This optimization is a routine step performed for any polyethylene-based material. Those skilled in the art would be able to perform this routine optimization without undue experimentation. Parameters to optimize included reheat temperature profile, blowing time, blow delay, max stretch rod distance, stretch rod pressure, and blow pressure. The presence of holes in the final container were assessed visually.

The digital description of the preform (10) was evaluated by determining whether the preform (10) could actually be transformed into an object by a 3D printer (i.e. 3D Printable? in TABLE 2) and whether the preform (10) could be blown into a bottle or container by stretch blow molding (i.e. Blow Molding? in TABLE 2). Values for positive results were given by a “+” symbol. Values for negative results were given by a “−” symbol.

TABLE 2 shows that a preforms could be printed from all of the selected digital descriptions. However, not all of the digital descriptions would result in bottles after the stretch blow molding process. For example, Sample D was unable to be stretch blow molded into a bottle, while Samples E-I were blown into bottles. A difference between the two results is the body wall thickness and the neck wall thickness. Samples E-I had wall thicknesses of 1.40 mm and 2.80 at the neck and body, respectively. Sample D had a wall thickness of 1.62 mm and 3.10 mm at the neck and body, respectively. All samples had a road thickness, and thus a polymer road thickness of 0.7 mm. Thus,

TABLE 1
3D Print Build Parameters

| | Sample A | Sample B | Sample C |
|---|---|---|---|
| Diameter of Nozzle | 0.8 mm | 0.8 mm | 0.8 mm |
| Road Width | 0.7 mm | 0.7 mm | 0.7 mm |
| Optimized | CPE^{a} | CPE^{a} | CPE^{a} |
| Parameter Settings | | | |
| Infill Density | 100% | 100% | 100% |
| Infill Type | Linear | Concentric | Concentric |
| Layer Height | 0.2 mm | 0.2 mm | 0.2 mm |
| Filament Flow | 105% | 105% | 105% |
| Printing Temperature^{b} | 215/212 | 215/212 | 215/212 |

^{a}CPE is Co-polymer optimized parameter settings
^{b}Printing temperature for the initial layer/subsequent layers in degrees Centigrade

TABLE 2
3D Printed Preforms

| | Sample D | Sample E | Sample F | Sample G | Sample H | Sample I |
|---|---|---|---|---|---|---|
| Total Length | 50.00 | 50.00 | 80.00 | 90.00 | 100.00 | 76.00 |
| (mm) | | | | | | |
| Body Width^{a} | 20.10 | 19.80 | 19.80 | 19.80 | 19.80 | 19.80 |
| (mm) | | | | | | |
| Body Wall Thickness | 3.10/1.62^{b} | 2.80/1.40^{c} | 2.80 | 2.80 | 2.80 | 2.80 |
| (mm) | | | | | | |
| Neck Wall Thickness | 1.62 | 1.40 | 1.40 | 1.40 | 1.40 | 1.40 |
| (mm) | | | | | | |
| Road Thickness | 0.70 | 0.70 | 0.70 | 0.70 | 0.70 | 0.70 |
| (mm) | | | | | | |
| Angle A | 30° | 30° | 20° | 20° | 20° | 20° |
| Angle B | 20° | 20° | 20° | 20° | 20° | 20° |
| 3D Printable?^{d} | + | + | + | + | + | + |
| Blow Molding?^{d} | − | + | + | + | + | + |

^{a}The measurement from the exterior surface (31) of the body (30) of the preform (10) to the exterior surface (31) of the body (30) of the preform (10) at the opposite side of the preform (10)
^{b}The body wall thickness narrows from 3.10 mm to 1.62 mm at the neck (20) of the preform (10)
^{c}The body wall thickness narrows from 2.80 mm to 1.40 mm at the neck (20) of the preform (10)
^{d}A positive result (+) is where the preform could be 3D printed or blow molded into a container; a negative result (−) is where the preform could not be 3D printed or blow molded into a container

only Sample D had a wall thickness that was not a whole number multiple of the road width. While not wishing to be bound by theory, it is believed that the strongest walls, and those able to withstand the blowing pressures experienced during the blow molding process, were walls that were a whole number multiple of the road width, but not necessarily a thicker wall. Sample D would result in a partial polymer road while Samples E-I resulted in exactly 2 polymer roads or 4 polymer roads. This also minimized the void space between polymer roads by not spacing the roads out to infill the wall. This result is unexpected because a thinner wall produced a stronger wall.

Additionally, in all cases, the printed preform samples were shorter than the corresponding injection molded preform. The preforms were designed to be shorter to reduce the time needed to print the preform, which is almost entirely the result of printing in the z direction. Thus, a shorter preform speeds up production times significantly. In order to accommodate a shorter preform, thicker walls were designed in the 3D printed preforms (10), relative to a corresponding injection molded preform. The thicker walls in the 3D printed preforms (10) were designed to result in the same wall thickness in the final container as one blown from an injection molded preform.

Surprisingly, Samples D-I had self-supporting overhangs with angles of less than 45° with respect to the build plate (as in FIG. 2). Angle A and Angle B could be designed to be as low as 20° which is far below the 45° typically needed to prevent collapse of the overhangs. The overhangs were printed without any supporting structure required.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A preform for producing a blow molded article comprising:
an open-ended neck;
a body comprising one or more polymer roads; and
a closed endcap comprising one or more polymer roads and a self-supporting overhang at an angle of from about 45° to 0°.

2. The preform of claim 1, wherein the preform is made using additive manufacturing.

3. The preform of claim 1, wherein the one or more polymer roads forms a wall of the body with a thickness of about 2 mm to about 6 mm.

4. The preform of claim 3, wherein the wall of the body has a thickness that is a whole number multiple of a road width of the one or more polymer roads of the body.

5. The preform of claim 1, wherein the neck comprises one or more polymer roads forming a wall of the neck with a thickness of from about 1 mm to about 3 mm.

6. The preform of claim 5, wherein the wall of the neck has a thickness which is a whole number multiple of a road width of the one or more polymer roads of the neck.

7. The preform of claim 1, wherein the neck further comprises a self-supporting overhang at an angle of from about 45° to 0°.

8. The preform of claim 7, wherein the angle is from less than 45° to about 15°.

9. The preform of claim 1, wherein the one or more polymer roads of the endcap forms a wall of the endcap with a thickness of from about 2 mm to about 6 mm.

10. The preform of claim 9, wherein the wall of the endcap has a thickness which is a whole number multiple of a road width of the one or more polymer roads of the endcap.

11. The preform of claim 1, wherein the angle is from less than 45° to about 15°.

12. The preform of claim 1, wherein the overhang does not require a supporting structure.

13. The blow molded article produced from the preform of claim 1.

14. A preform for producing a blow molded article comprising:
an open-ended neck;
a body comprising one or more polymer roads forming a wall of the body; and
a closed endcap comprising one or more polymer roads forming a wall of the endcap,
wherein the wall of the body has a thickness which is a whole number multiple of a road width of the one or more polymer roads of the body.

15. The preform of claim 14, wherein the endcap comprises a self-supporting overhang at an angle of from less than 45° to about 15°.

16. The blow molded article produced from the preform of claim 14.

17. A method for manufacturing a blow molded article comprising:
(a) Providing a digital description of a three-dimensional preform;
(b) Depositing concentrically filled polymer roads in accordance with a first layer of the digital description;
(c) Incrementally depositing successive layers on top of the first layer to generate the preform; and
(d) Forming a blow molded article from the preform using a blow molding process.

18. The method of claim 17, wherein the digital description is a CAD file.

19. The method of claim 17, wherein the blow molding process comprises:
(a) Placing the preform in a mold cavity;
(b) Heating the preform above a glass transition temperature of the preform; and
(c) Introducing a pressurized medium into the preform to form a blow molded article

20. The method of claim 19, wherein the pressurized medium is selected from compressed air, nitrogen, argon, or oxygen.

21. The method of claim 15, wherein depositing concentrically filled polymer roads comprises infilling an area between an interior road and an exterior road concentric to the two-dimensional shape of the interior road and exterior road.

22. A preform for producing a blow molded article comprising:
an open-ended neck comprising a wall of the neck, wherein the wall of the neck has a thickness of from about 1 mm to about 3 mm;
a body comprising a wall of the body, wherein the wall of the body has a thickness of from about 2 mm to about 6 mm; and
a closed endcap comprising a wall of the endcap and an overhang at a self-supporting angle of from less than 45° to about 15°, wherein the wall of the endcap has a thickness of from about 2 mm to about 6 mm.

23. The blow molded article produced from the preform of claim 22.
